(19) United States
(12) Patent Application Publication
(10) Pub. No.: US 2023/0041473 A1
(43) Pub. Date: Feb. 9, 2023

(54) CONTROLLING TARGET TEMPERATURE OF FIXING UNIT

(71) Applicant: HEWLETT-PACKARD DEVELOPMENT COMPANY, L.P., Spring, TX (US)

(72) Inventors: Jeongchul Song, Seongnam Si (KR); Sanguk Jeon, Suwon (KR); Hwachul Choi, Pangyo (KR)

(21) Appl. No.: 17/757,897

(22) PCT Filed: Aug. 27, 2020
(86) PCT No.: PCT/US2020/048122

§ 371 Date: Jun. 23, 2022

(30) Foreign Application Priority Data
Mar. 13, 2020 (KR) 1020200031153

(51) Int. Cl. G03G 15/20

(52) U.S. Cl. CPC G03G 15/2039

(57) ABSTRACT

An example fixing device includes a heating member, a pressing member to form a fixing nip with the heating member, a temperature sensor to sense a temperature at a first point of the heating member, and a processor to set a target temperature lower than a first set temperature at which normal fixing is possible for the entire area of a print medium in a case where a distribution of an image for a first area, which is a certain outer area of the print medium, is less than a certain criterion, and control power supplied to he heating member such that the temperature at the first point sensed by the temperature sensor reaches the set target temperature.

### BACKGROUND

An image forming apparatus such as a printer, a copier, a scanner, a fax machine, or a multi-function printer may transfer a print medium loaded in a loading portion to an image forming portion of the image forming apparatus to form a toner image on the print medium and may pass the toner image through a fixing device, thereby fixing the toner image on the print medium. The fixing device may maintain a temperature and a pressure within a certain range to maintain a toner's fixing level or fusing level above a certain level. When the temperature of a fixing nip is too low, toner may not be properly fixed on the print medium, and when the temperature of the fixing nip is too high, toner may stick to a roller of the fixing device.

### BRIEF DESCRIPTION OF THE DRAWINGS

FIG. 1 illustrates a structure and an operation of an image forming apparatus according to an example.

FIGS. 2A and 2B illustrate a relationship between a target temperature for controlling an amount of heat generated by a fixing device and a fixing level and energy efficiency performance of the fixing device according to an example.

FIG. 3 illustrates temperature distribution characteristics of a fixing device according to various target temperatures and a fixing capability of the fixing device in an area of a print medium according to an example.

FIGS. 4A and 4B illustrate areas of a print medium separately to describe the areas of the print medium according to an example.

FIG. 5 illustrates a method of controlling a temperature of a fixing device according to an example.

FIG. 6 illustrates a method of controlling a temperature of a fixing device according to an example.

FIG. 7 illustrates a portion of a heating member in a fixing device including a plurality of heat sources, the heating member being heated by each of the heat sources, an area of a print medium corresponding thereto, and a fixing capability of the fixing device in the area of the print medium according to an example.

FIGS. 8A and 8B illustrate areas of a print medium separately to describe the areas of the print medium according to an example.

FIG. 9 illustrates a method of controlling a temperature of a fixing device including a plurality of heat sources according to an example.

FIG. 10 illustrates a method of controlling a temperature of a fixing device including a plurality of heat sources according to an example.

### DETAILED DESCRIPTION OF EXAMPLES

Reference will now be made to examples that are illustrated in the accompanying drawings. The same reference numerals are used to denote the same elements, and repeated descriptions thereof will not be given herein.

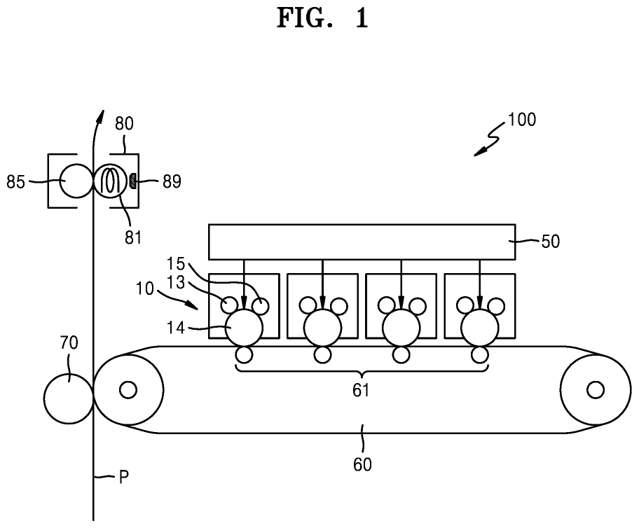

FIG. 1 illustrates a structure and an operation of an image forming apparatus. The image forming apparatus of the following example may print a color image by an electrophotographic development method.

Referring to FIG. 1, an image forming apparatus 100 collectively refers to an apparatus capable of performing an image forming job, such as a printer, a copier, a scanner, a multi-function printer, or a fax machine. An image forming job may refer to any of various jobs related to an image, for example, printing, copying, scanning, faxing, or the like, and may include a series of processes necessary for performing an image forming job.

A developing device 10 may include a photoconductor 14 on which an electrostatic latent image may be formed and a developing roller 13 for supplying a developer to the electrostatic latent image to develop the electrostatic latent image into a visible toner image. A photosensitive drum may be, for example, an organic photoconductor (OPC). A charging roller 15 is an example of a charger that charges the photoconductor 14 to have a uniform surface electric potential. A developer accommodated in a developer cartridge (not shown) may be supplied to the developing device 10. The developer accommodated in the developer cartridge (not shown) may be toner.

An optical scanning device 50 is a device that forms an electrostatic latent image on the photoconductor 14 by scanning light modulated corresponding to image information onto the photoconductor 14, and a typical example is a laser scanning unit (LSU).

A transfer device transfers a toner image formed on the photoconductor 14 to the print medium P and may use an intermediate transfer method. For example, as illustrated in FIG. 1, the transfer device may include an intermediate transfer body 60, an intermediate transfer roller 61, and a transfer roller 70. An intermediate transfer belt shown in FIG. 1 is an example of the intermediate transfer body 60 to which toner images developed on a plurality of photoconductors 14 of a plurality of developing devices 10 are transferred and may temporarily accommodate the toner images. An intermediate transfer bias for intermediate transfer of the toner images developed on the photoconductors 14 to the intermediate transfer body 60 may be applied to a plurality of intermediate transfer rollers 61. The transfer roller 70 may be located to face the intermediate transfer body 60.

The print medium P may be conveyed between the transfer roller 70 and the intermediate transfer body 60 along a paper feeding path. A toner image intermediately transferred onto the intermediate transfer body 60 by applying a transfer bias voltage to the transfer roller 70 may be further transferred to the print medium P conveyed between the transfer roller 70 and the intermediate transfer body 60.

When the print medium P passes through a fixing device 80, a toner image is fixed to the print medium P by heat and/or pressure. Depending on the type of the fixing device 80, the shape of a heating member 81 for applying heat and the shape of a pressing member 85 for applying pressure may be different from each other. For example, the fixing device 80 may have a 2-Roll type, a 3-Roll type, a free belt nip fuser (FBNF) type using a pressing belt with a built-in pressing portion, an instantaneous fusing system (IFS) type using a heating belt with a pressing portion, an on-demand fusing (ODF) type, an induction heating (IH) type, etc. The heating member 81 or the pressing member 85 may be in the form of a roller or a belt, depending on the type of the fixing device 80. The heating member 81 may include a single heat source or a plurality of heat sources, and the heat source may be a heating lamp, a ceramic heater, etc. The fixed print medium P may be discharged by a discharge roller (not shown). A temperature sensor 89 may sense the temperature of the heating member 81 corresponding to a point where the temperature sensor 89 is arranged, and may be arranged to sense a surface temperature of the heating member 81 or the temperature of a heat source in the heating member 81 according to the type of the heating member 81. For example, because it is expected that a temperature distribution of the heating member 81 may appear in a symmetrical shape in the left and right with respect to a central portion of the heating member 81, the temperature sensor 89 may be arranged to sense the temperature of a point corresponding to the center of the heat source in the heating member 81 or the surface of the heating member 81, but is not limited thereto. Depending on the type of the fixing device 80 or the structure of the fixing device 80, the temperature sensor 89 may be arranged to sense a temperature at a certain point of the heating member 81 and may include a plurality of temperature sensors to sense the temperature of each portion of the heating member 81.

In the above-described example, the optical scanning device 50 may scan light modulated corresponding to image information of each color to the photoconductor 14 corresponding to the each color, thereby forming an electrostatic latent image corresponding to the each color on the photoconductor 14. An electrostatic latent image of each of the photoconductor 14 of the plurality of developing devices 10 may be developed into a visible toner image by a developer supplied to the plurality of developing devices 10 from a plurality of developer cartridges (not shown). The developed toner images are transferred to the print medium P after being intermediately transferred to the intermediate transfer body 60, and when the print medium P passes through the fixing device 80, the toner images are fixed to the print medium P.

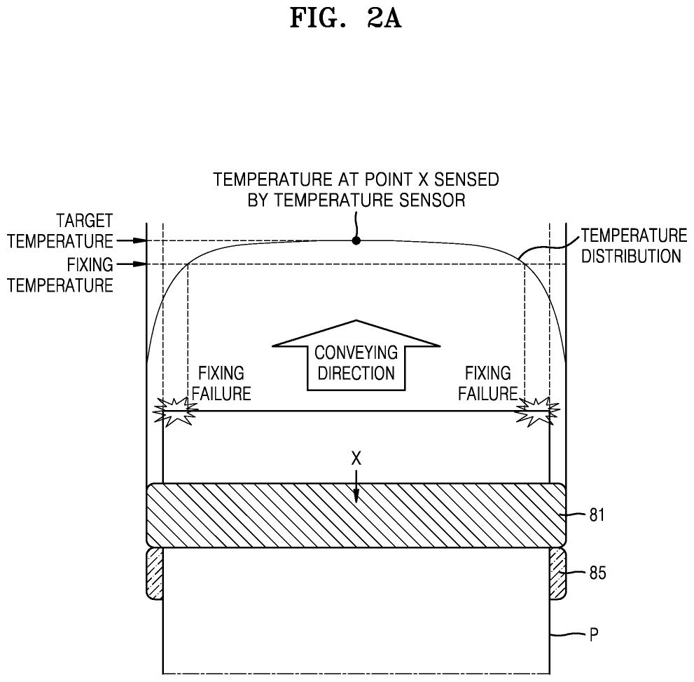

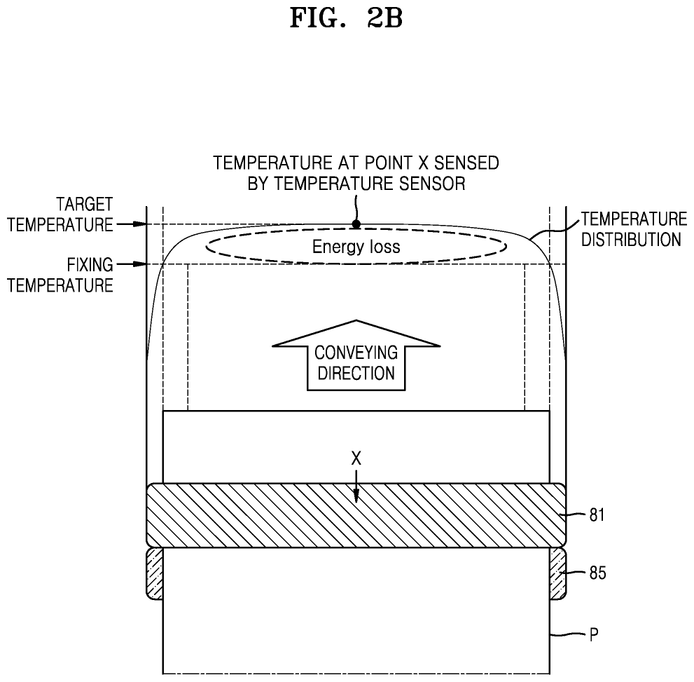

FIGS. 2A and 2B illustrate a relationship between a target temperature for controlling an amount of heat generated by a fixing device and a fixing level and energy efficiency performance of the fixing device according to an example.

Referring to FIG. 2A, the print medium P may be transferred to a fixing nip formed by the heating member 81 and the pressing member 85 in a process of fixing a toner image formed on the print medium P.

The heating member 81 and the pressing member 85 may be rotated against each other. The heating member 81 includes a heat source that generates heat in a longitudinal direction (i.e., a rotation axis direction). The amount of heat transferred to the toner image formed on the print medium P may correspond to the temperature of the heating member 81. The heating member 81 may have a different thermal resistance distribution in the longitudinal direction, and both end portions of the heating member 81 may have less thermal resistance than a central portion thereof. When measuring the temperature of the heating member 81 with respect to the longitudinal direction of the heating member 81 using a separate temperature measuring device, as illustrated in a temperature distribution shown in FIG. 2A, the temperature at both end portions of the heating member 81 is lower than the temperature at the central portion. Even if temperature at a point X sensed by the temperature sensor 89 reaches a target temperature that is higher than a fixing temperature, as shown in FIG. 2A, the temperature at both end portions of the heating member 81 may be lower than the fixing temperature. As a result, a fixing failure may occur in an area of the print medium P corresponding to both end portions of the heating member 81.

The term “fixing temperature” refers to a temperature at which fixing is possible and refers to a minimum temperature to perform fixing.

The term “target temperature” refers to a temperature at a certain point of the fixing device 80 sensed by the temperature sensor 89 that the fixing device 80 needs to reach. The target temperature is a variable used to control power supplied to the heating member 81, and the fixing device 80 may supply or cut off power to or from the heating member 81 such that the temperature at the point X sensed by the temperature sensor 89 reaches the target temperature. For example, while a temperature is being sensed at a certain point of the heat source in the heating member 81 or the surface of the central portion of the heating member 81 by the temperature sensor 89, the fixing device 80 may supply or cut off power to or from the heating member 81 until the temperature at the certain point reaches the target temperature.

In an example, the target temperature may be set based on image information regarding a preset area of the print medium P. Thus, the target temperature may be set differently for each page to be printed. For example, the target temperature may be set according to a result of comparing a distribution of an image with respect to a certain outer area of the print medium P with a certain criterion. A distribution of an image in a certain area refers to a degree of distribution of an image to be printed in a corresponding area, and may be a measure indicating whether the amount of an image to be printed in the area is large or small. When there is no image to be printed in a preset area of the print medium P or when an amount of an image is less than a certain criterion, a target temperature may be set lower than when there is an image to be printed in the preset area or when the amount of the image is more than the certain criterion. In an example, the less a distribution of an image with respect to the preset area of the print medium P, the lower the target temperature may be set.

According to an example thermal resistance distribution in the longitudinal direction of the heating member 81, as shown in FIG. 2A, the temperature distribution of the heating member 81 has a characteristic that both end portions of the heating member 81 have a lower temperature than the central portion, which is the point X sensed by the temperature sensor 89. Therefore, in order to enable normal fixing for the entire area in the width direction of the print medium P corresponding to the longitudinal direction of the heating member 81, the target temperature needs to be set higher in consideration of the low temperature characteristics of both end portions of the heating member 81.

As an example, referring to FIG. 2B, by setting the target temperature at the point X sensed by the temperature sensor 89 higher than that of FIG. 2A, it can be seen that a temperature capable of normal fixing is maintained for the entire area in the width direction of the print medium P corresponding to the longitudinal direction of the heating member 81.

When the target temperature of the fixing device 80 is set high, a fixing failure may be reduced or prevented in the entire area in the width direction of the print medium P, and a fixing level may be improved. However, when comparing the case of FIG. 2A and the case of FIG. 2B in terms of energy efficiency performance, in the case of FIG. 2B, it can be seen that power consumption increases and energy loss increases, resulting in a lower energy efficiency performance. That is, the higher the target temperature used to control the power supplied to the heating member 81 for the heating of the heating member 81, the higher the fixing level of the fixing device 80, while the energy efficiency performance is lowered. Therefore, it can be seen that the case of FIG. 2A and the case of FIG. 2B are in a trade-off relationship with each other.

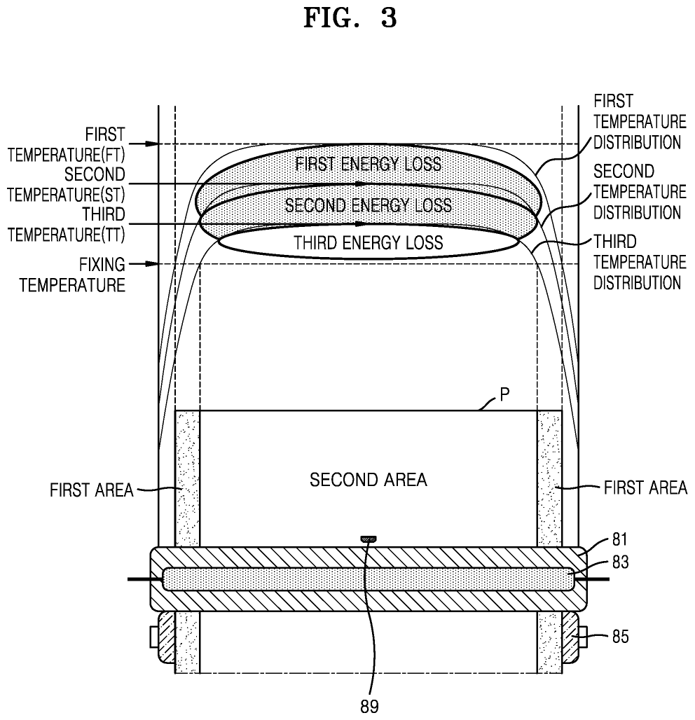

FIG. 3 illustrates temperature distribution characteristics of a fixing device according to various target temperatures and a fixing capability of the fixing device in an area of a print medium according to an example.

Referring to FIG. 3, the fixing device 80 may include the heating member 81 including one heat source 83, the pressing member 85 forming a fixing nip with the heating member 81, and the temperature sensor 89 to sense a temperature at a first point of the heating member 81. It can be seen that, depending on the temperature distribution characteristics of the heating member 81, the amount of heat transferred from the heating member 81 to the print medium P passing through the fixing nip of the fixing device 80 may be different.

As shown in FIG. 3, when a target temperature is a first temperature FT, a second temperature ST, and a third temperature TT, respectively, a corresponding first temperature distribution, second temperature distribution, and third temperature distribution are compared as follows.

When the target temperature is the first temperature FT, the first temperature distribution of the entire area of the print medium P is equal to or greater than a fixing temperature, so it can be seen that there is no area in the print medium P where a fixing failure may occur. When the target temperature is the second temperature ST, because the second temperature distribution is lower than the fixing temperature for some areas at both end portions of the print medium P in the width direction, a fixing failure may occur in some areas of a first area of the print medium P. When the target temperature is the third temperature TT, because the third temperature distribution is lower than the fixing temperature for the first area at both end portions of the print medium P in the width direction, a fixing failure may occur in the first area of the print medium P. When comparing a first energy loss at the first temperature FT, a second energy loss at the second temperature ST, and a third energy loss at the third temperature TT, it can be seen that energy loss is reduced as the target temperature is reduced.

In an example, the performance of the fixing device 80 may be adjusted by setting a target temperature for each page to be printed such that energy loss may be reduced while maintaining a fixing level.

A processor (not shown) of the fixing device 80 may supply power to the heating member 81 based on a first set temperature at which normal fixing is possible for the entire area of the print medium P according to a print job command. The first set temperature is temperature at a certain point of the heating member 81 at which normal fixing is possible for the entire area of the print medium P. The first set temperature may be a value previously measured in order to improve a fixing level of both end portions of the fixing device 80. The first set temperature is a temperature at which normal fixing is possible for the entire area of the print medium P, and may be the lowest temperature to obtain normal fixing for the entire area in the width direction of the print medium P corresponding to the longitudinal direction of the heating member 81. The first set temperature may already be stored as a specific temperature value in a memory (not shown), and the processor (not shown) of the fixing device 80 may control power supplied to the heating member 81 with reference to the first set temperature already stored in the memory according to a print job command. The first set temperature may be the lowest temperature among temperatures to obtain normal fixing for the entire area of the print medium P, and the value may be changed according to the setting of a user or administrator. However, according to the print job command, the process of supplying power to the heating member 81 based on the first set temperature may be performed before setting a target temperature for a first page to be printed or may be omitted.

The processor (not shown) of the fixing device 80 may set a target temperature equal to or lower than the first set temperature based on image information for the first area that is a certain outer area of the print medium P. The processor (not shown) of the fixing device 80 may set a target temperature lower than the first set temperature when a distribution of an image for the first area of the print medium P is less than a certain criterion. For example, the processor (not shown) of the fixing device 80 may set a target temperature to be lower as a distribution of an image for the first area is less. The processor (not shown) of the fixing device 80 may control the power supplied to the heating member 81 such that a temperature at the first point sensed by the temperature sensor 89 reaches the set target temperature.

According to a temperature rise performance of the fixing device 80 or a data processing performance of the processor (not shown), a target temperature may be set before the temperature at the first point sensed by the temperature sensor 89 reaches the first set temperature. When a target temperature lower than the first set temperature is set before the temperature at the first point sensed by the temperature sensor 89 reaches the first set temperature, the processor (not shown) of the fixing device 80 may control the power supplied to the heating member 81 such that the temperature sensed by the temperature sensor 89 reaches the set target temperature without reaching the first set temperature. According to this, by not increasing the temperature of the heating member 81 such that the temperature at the first point sensed by the temperature sensor 89 reaches the first set temperature and by controlling the power supplied to the heating member 81 such that the temperature at the first point reaches a target temperature that is lower than the first set temperature, a first page out time (FPOT) may be reduced, curl generation of the print medium P may be reduced, and energy loss may be reduced.

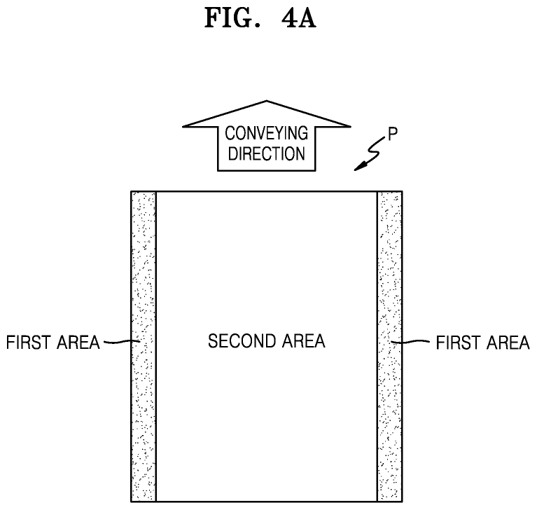

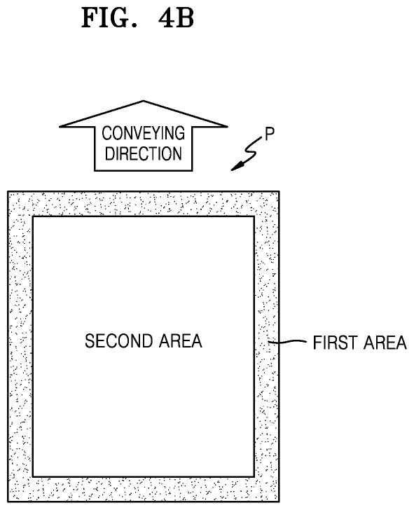

FIGS. 4A and 4B illustrate areas of a print medium separately to describe the areas of the print medium P according to an example.

A target temperature for each page to be printed may be set based on image information for a certain outer area of the print medium P. Referring to FIGS. 4A and 4B, an example will be described of defining the outer area. However, the examples are not limited thereto.

FIG. 4A is an example in which the area of the print medium P corresponding to both end portions of the heating member 81 is taken as the outer area in consideration of a temperature distribution characteristic of the heating member 81. Referring to FIG. 4A, the print medium P may be divided into a first area that is a certain outer area and a second area that corresponds to a central area.

A front end area and a rear end area, which are areas within a first range from each of a leading edge and a trailing edge in a conveying direction of the print medium P, may have a lower fixing level than a central area between the front end area and the rear end area. As an example, when the print medium P of various basis weights due to the size or material of the print medium P is supported in the image forming apparatus 100, fixing levels of the front end area and the rear end area may be poor depending on the basis weight of the print medium P. In this case, an outer area of the print medium P illustrated in FIG. 4B may be the first area. It can be seen that the first area of FIG. 4B includes an area within the first range from each of a leading edge and a trailing edge of the print medium P in the conveying direction and an area within a second range from both edges of the print medium P in a width direction.

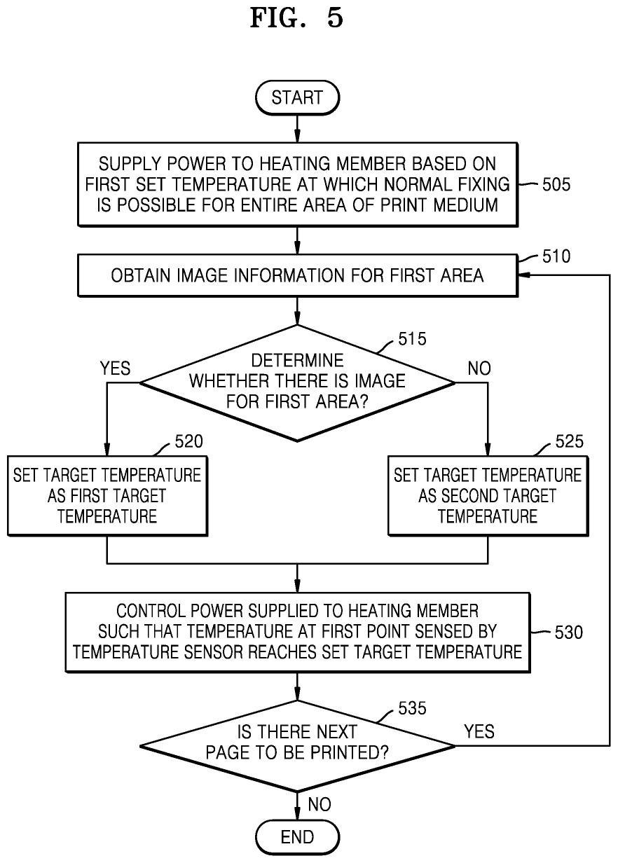

FIG. 5 illustrates a method of controlling a temperature of a fixing device according to an example.

Referring to FIG. 5, the fixing device 80 may supply power to the heating member 81 based on a first set temperature at which normal fixing is possible for the entire area of the print medium P in operation 505. The fixing device 80 may supply power to the heating member 81 based on the first set temperature at which normal fixing is possible for the entire area of the print medium P in a width direction corresponding to a longitudinal direction of the heating member 81. However, such a process is not necessarily performed, and may be applied as a preceding process if necessary.

In operation 510, the fixing device 80 may obtain image information for a first area that is a certain outer area of the print medium P. For example, the fixing device 80 may obtain image information for the first area within a certain range from both edges of the print medium P in the width direction.

In operation 515, the fixing device 80 may determine whether there is an image for the first area.

In operation 520, the fixing device 80 may set a target temperature as a first target temperature when there is an image for the first area. In an example, the first target temperature is below a first set temperature.

In operation 525, the fixing device 80 may set the target temperature to a second target temperature lower than the first target temperature when there is no image for the first area.

In operation 530, the fixing device 80 may control the power supplied to the heating member 81 such that the temperature at the first point sensed by the temperature sensor 89 reaches the set target temperature.

In operation 535, the fixing device 80 may determine whether there is a next page to be printed. When there is a next page to be printed, returning to operation 510, a target temperature control process for the next page may proceed, and when there is no next page to be printed, the print job may end. The fixing device 80 may perform a process of controlling the target temperatures in operations 510 to 530 for each page to be printed.

Table 1 below shows a difference between a target temperature according to the presence or absence of an image for the first area, and the resulting FPOT and fixing power consumption. When there is no image for the first area, the target temperature may be decreased by 8° C. as compared to when there is an image for the first area, and accordingly, the FPOT decreases by 9.5% and the fixed power consumption decreases by 3.1%.

TABLE 1

| | When there is | When there is | |
|---|---|---|---|
| | image for | no image for | |
| | first area | second area | Remarks |
| Target | 181 | 173 | Decreased |
| temperature | | | by 8° C. |
| (° C.) | | | |
| FPOT (sec) | 17.48 | 15.82 | Decreased |
| | | | by 9.5% |
| Fixed power | 415.5 | 402.5 | Decreased |
| consumption | | | by 3.1% |
| (wh) | | | |

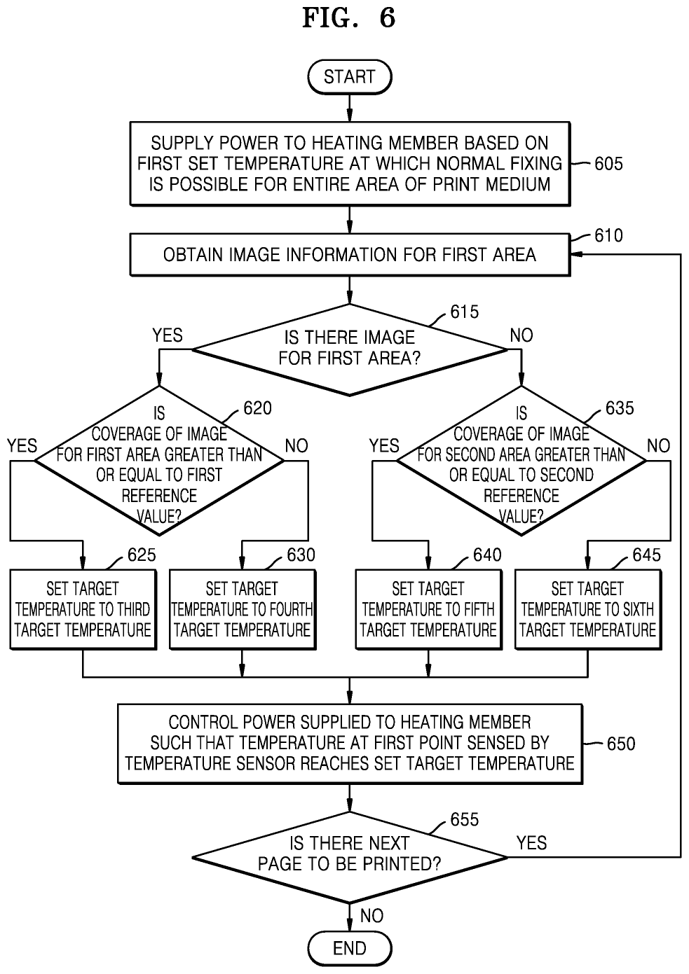

FIG. 6 illustrates a method of controlling a temperature of a fixing device according to an example.

Referring to FIG. 6, the fixing device 80 may supply power to the heating member 81 based on a first set temperature at which normal fixing is possible for the entire area of the print medium P in operation 605. The fixing device 80 may supply power to the heating member 81 based on the first set temperature at which normal fixing is possible for the entire area of the print medium P in a width direction corresponding to a longitudinal direction of the heating member 81. However, such a process is not necessarily performed, and may be applied as a preceding process if necessary.

In operation 610, the fixing device 80 may obtain image information for a first area. The fixing device 80 may obtain image information for the first area within a certain range from both edges of the print medium P in the width direction. The fixing device 80 may obtain image information of print data for each area of the print medium P. The fixing device 80 may obtain image information for the second area as well as image information for the first area in FIG. 4A or FIG. 4B.

In operation 615, the fixing device 80 may determine whether there is an image for the first area.

In operation 620, when there is an image for the first area, the fixing device 80 may determine whether the coverage of the image for the first area of the print medium P is greater than or equal to a first reference value or the image for the first area includes an image other than text (e.g., is not made of text only). The coverage of the image refers to a value indicating an amount of toner consumed in a corresponding area, and may be determined by the number of pixels or the number of dots in the image for the corresponding area. The first reference value may be a preset value, and the value may be changed by a user or an administrator.

In operation 625, when the coverage of the image for the first area of the print medium P is greater than or equal to the first reference value, or when the image for the first area includes an image other than text, the fixing device 80 may set a target temperature to a third target temperature below the first set temperature.

In operation 630, when the coverage of the image for the first area of the print medium P is less than the first reference value, or when the image for the first area does not include an image other than text (e.g., is made of text only), the fixing device 80 may set the target temperature to a fourth target temperature lower than the third target temperature.

In operation 635, when there is no image for the first area, the fixing device 80 may determine whether the coverage of the image for the second area excluding the first area in the entire area of the print medium P is greater than or equal to the second reference value or the image for the second area includes an image other than text. The second reference value may be a preset value, and the value may be changed by a user or an administrator.

In operation 640, when the coverage of the image for the second area of the print medium P is greater than or equal to the second reference value, or when the image for the second area includes an image other than text, the fixing device 80 may set the target temperature to a fifth target temperature.

In operation 645, when the coverage of the image for the second area of the print medium P is less than the second reference value, or when the image for the second area does not include an image other than text, the fixing device 80 may set the target temperature to a sixth target temperature lower than the fourth and fifth target temperatures.

In operation 650, the fixing device 80 may control the power supplied to the heating member 81 such that the temperature at the first point sensed by the temperature sensor 89 reaches the set target temperature.

In operation 655, the fixing device 80 may determine whether there is a next page to be printed. When there is a next page to be printed, returning to operation 610, a target temperature control process for the next page may proceed, and when there is no next page to be printed, the print job may end. The fixing device 80 may perform a process of controlling the target temperatures of operations 610 to 650 for each page to be printed.

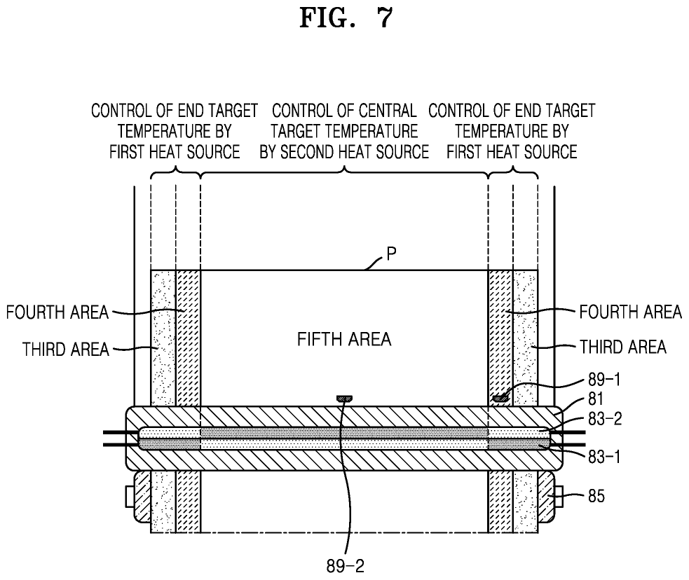

FIG. 7 illustrates a portion of a heating member in a fixing device including a plurality of heat sources, the heating member being heated by each of the heat sources, an area of a print medium corresponding thereto, and a fixing capability of the fixing device in the area of the print medium according to an example.

Referring to FIG. 7, the heating member 81 of the fixing device 80 may include a plurality of heat sources. As shown in FIG. 7, the heating member 81 may include a first heat source 83-1 for heating both end portions of the heating member 81 and a second heat source 83-2 for heating a central portion between both end portions. A first temperature sensor 89-1 may sense a temperature at a second point of either of both end portions of the heating member 81, and a second temperature sensor 89-2 may sense a temperature at a third point of a central portion of the heating member 81.

The print medium P may include a fifth area fixed by the central portion of the heating member 81 heated by the second heat source 83-2, and a third area and a fourth area fixed by both end portions of the heating member 81 heated by the first heat source 83-1.

According to the example fixing device 80 including a plurality of heat sources as shown in FIG. 7, the fifth area fixed by the central portion of the heating member 81 may be heated according to the control of a central target temperature by the second heat source 83-2, and the third area and the fourth area fixed by both end portions of the heating member 81 may be heated according to the control of an end target temperature by the first heat source 83-1.

The central target temperature refers to a temperature that the third point sensed by the second temperature sensor 89-2 of the fixing device 80 needs to reach. The central target temperature is a variable used to control power supplied to the second heat source 83-2, and the fixing device 80 may supply or cut off power to or from the second heat source 83-2 such that the temperature sensed by the second temperature sensor 89-2 reaches the central target temperature. For example, while sensing the temperature at the third point of the heat source in the central portion of the heating member 81 or the surface of the central portion of the heating member 81 with the second temperature sensor 89-2, the fixing device 80 may supply or cut off power to or from the second heat source 83-2 until the temperature at the third point reaches the central target temperature.

The end target temperature refers to a temperature that the second point sensed by the first temperature sensor 89-1 of the fixing device 80 needs to reach. The end target temperature is a variable used to control power supplied to the first heat source 83-1, and the fixing device 80 may supply or cut off power to or from the first heat source 83-1 such that the temperature sensed by the first temperature sensor 89-1 reaches the end target temperature. For example, while sensing the temperature at the second point of the heat source in both end portions of the heating member 81 or the surface of both end portions of the heating member 81 with the first temperature sensor 89-1, the fixing device 80 may supply or cut off power to or from the first heat source 83-1 until the temperature at the second point reaches the end target temperature.

Both end portions of the heating member 81 may have a lower temperature in an outer portion thereof than the temperature in an inner portion thereof toward the central portion of the heating member 81. As a result, as shown in FIG. 2A above, because a temperature of a portion of both end portions of the heating member 81 is lower than a fixing temperature, a fixing failure may occur in an outer area of the print medium P. That is, a fixing failure may occur in the third area among the areas of the print medium P fixed by the end portions of the heating member 81 heated by the first heat source 83-1.

To address this fixing failure, by setting the end target temperature used to control the first heat source 83-1 for controlling the amount of heat generated at both end portions of the heating member 81, normal fixing may be possible for the third and fourth areas of the print medium P corresponding to both end portions of the heating member 81. In an example, the performance of the fixing device 80 may be adjusted by setting the end target temperature for each page to be printed such that energy loss may be reduced while maintaining a fixing level.

A processor (not shown) of the fixing device 80 may supply power to the first heat source 83-1 based on a second set temperature at which normal fixing is possible for the third and fourth areas according to a print job command. The second set temperature may be the lowest temperature to obtain normal fixing for the third and fourth areas of the print medium P corresponding to both end portions of the heating member 81. The second set temperature may already be stored as a specific temperature value in a memory (not shown), and the processor (not shown) of the fixing device 80 may control power supplied to the heat source 83 with reference to the second set temperature already stored in the memory according to a print job command.

The processor (not shown) of the fixing device 80 may set the end target temperature lower than the second set temperature when a distribution of an image for the third area, which is the outer area than the fourth area, is less than a certain criterion. The processor (not shown) of the fixing device 80 may control power supplied to the first heat source 83-1 such that the temperature at the second point sensed by the first temperature sensor 89-1 reaches the set end target temperature.

When the end target temperature that is lower than the second set temperature is set before the temperature at the second point sensed by the first temperature sensor 89-1 reaches the second set temperature, the processor (not shown) of the fixing device 80 may control the power supplied to the first heat source 83-1 such that the temperature at the second point sensed by the first temperature sensor 89-1 reaches the set end target temperature without reaching the second set temperature. According to this, by not increasing the temperature of both end portions of the heating member 81 such that the temperature at the second point sensed by the first temperature sensor 89-1 reaches the second set temperature and by controlling the power supplied to the first heat source 83-1 such that the temperature at the second point reaches the end target temperature that is lower than the second set temperature, an FPOT may be reduced, curl generation of the print medium P may be reduced, and energy loss may be reduced.

For each page to be printed, in order to control the central target temperature, the processor (not shown) of the fixing device 80 may supply power to the second heat source 83-2 based on a third set temperature at which normal fixing is possible for the fifth area according to a print job command. The third set temperature may be the lowest temperature to obtain normal fixing for the fifth area of the print medium P corresponding to the central portion of the heating member 81. The third set temperature may already be stored as a specific temperature value in the memory (not shown), and the processor (not shown) of the fixing device 80 may control power supplied to the second heat source 83-2 with reference to the third set temperature already stored in the memory (not shown) according to a print job command. When a distribution of an image for the fifth area is less than a certain criterion, the processor (not shown) of the fixing device 80 may set the central target temperature lower than the third set temperature, and may control the power supplied to the second heat source 83-2 such that the temperature at the third point sensed by the second temperature sensor 89-2 reaches the set central target temperature.

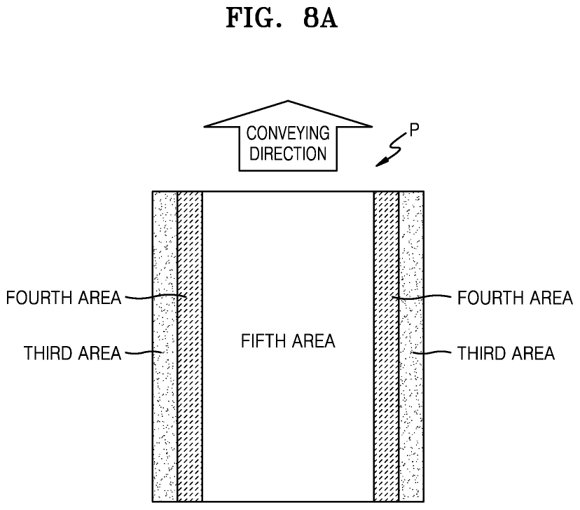

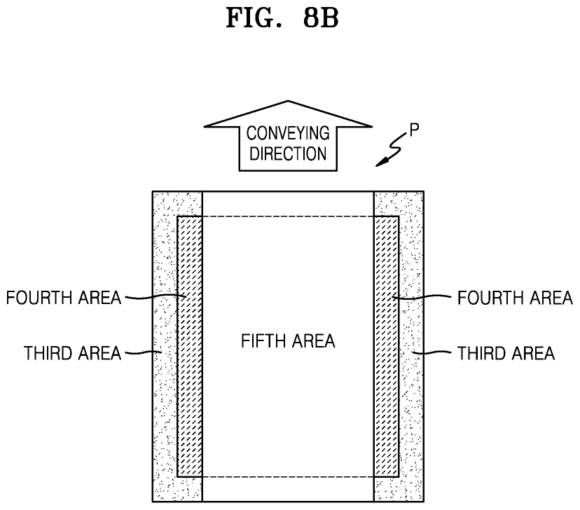

FIGS. 8A and 8B illustrate areas of a print medium separately to describe the areas of the print medium according to an example.

The end target temperature and the central target temperature for each page to be printed may be set based on image information for each area of the print medium P. The end target temperature may be set based on image information for third and fourth areas of the print medium P. A lower distribution of an image for the third area corresponds to a lower end target temperature that may be set. The central target temperature may be set based on image information for a fifth area of the print medium P. The less a distribution of an image for the fifth area, the lower the central target temperature may be set.

FIG. 8A is an example in which an outer area is the third area and the other is the fourth area in an area of the print medium P corresponding to both end portions of the heating member 81 in consideration of temperature distribution characteristics of the heating member 81. It can be seen that, compared to the third area of FIG. 8A, the third area of FIG. 8B further includes an area within a certain range from each of a leading edge and a trailing edge of the print medium P in a conveying direction in the area of the print medium P corresponding to both end portions of the heating member 81.

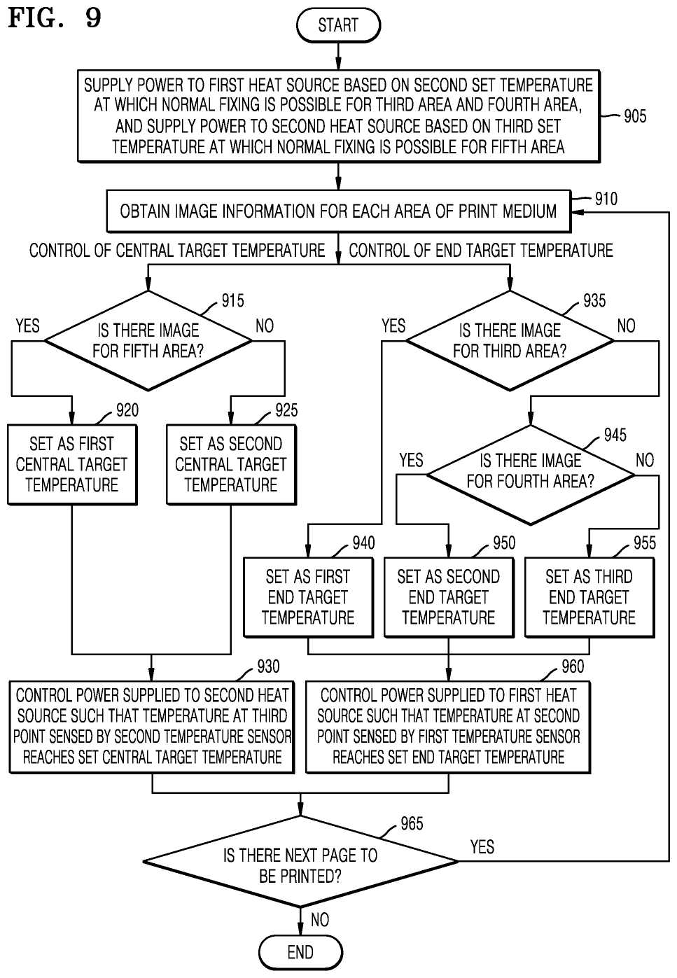

FIG. 9 illustrates a method of controlling a temperature of a fixing device including a plurality of heat sources according to an example.

Referring to FIG. 9, the fixing device 80 may supply power to the first heat source 83-1 based on a second set temperature at which normal fixing is possible for third and fourth areas, and may supply power to the second heat source 83-2 based on a third set temperature at which normal fixing is possible for a fifth area in operation 905. The fixing device 80 may supply power to the heating member 81 based on the second set temperature and the third set temperature at which normal fixing is possible for the entire area of the print medium P in a width direction corresponding to a longitudinal direction of the heating member 81. The fixing device 80 may supply power corresponding to the second set temperature and the third set temperature to the first heat source 83-1 for heating both end portions of the heat member 81 in the longitudinal direction and the second heat source 83-2 for heating a central portion between both end portions, respectively. However, such a process is not necessarily performed, and may be applied as a preceding process if necessary.

In operation 910, the fixing device 80 may obtain image information for each area of the print medium P. For example, the fixing device 80 may obtain image information for each of the third area, the fourth area, and the fifth area of the print medium P of FIG. 8A or FIG. 8B. Thereafter, the fixing device 80 may independently perform processes (corresponding to operations 935 to 960) of controlling the end target temperature and processes (corresponding to operations 915 to 930) of controlling the central target temperature, respectively.

In operation 915, the fixing device 80 may determine whether there is an image for the fifth area of the print medium P.

In operation 920, the fixing device 80 may set the central target temperature as a first central target temperature when there is an image for the fifth area of the print medium P. The first central target temperature is equal to or less than the second set temperature.

In operation 925, the fixing device 80 may set the central target temperature as a second central target temperature lower than the first central target temperature when there is no image for the fifth area of the print medium P.

In operation 930, the fixing device 80 may control power supplied to the second heat source 83-2 such that a temperature at a third point sensed by the second temperature sensor 89-2 reaches the set central target temperature.

The example processes of operations 915 to 930 above for controlling the central target temperature may be modified and performed according to another example. For example, different from the example shown in FIG. 9, for each page to be printed, the fixing device 80 may set the central target temperature to a sixth central target temperature when there is an image for a front end area and a rear end area within a certain range from each of the leading edge and the trailing edge of the print medium P in a conveying direction in the fifth area, may set the central target temperature to a seventh central target temperature lower than the sixth central target temperature when there is no image corresponding to the front end area and the rear end area, and may control power supplied to the second heat source 83-2 such that the temperature at the third point sensed by the second temperature sensor 89-2 reaches the set central target temperature.

In another example, the fixing device 80 may set the central target temperature to a certain temperature regardless of the image information of the print medium P to control the power supplied to the second heat source 83-2, and a process for controlling the end target temperature may set the end target temperature based on the image information of the print medium P to control the power supplied to the first heat source 83-1.

Referring again to FIG. 9, in operation 935, the fixing device 80 may determine whether there is an image for the third area of the print medium P.

In operation 940, the fixing device 80 may set the end target temperature as a first end target temperature when there is an image for the third area of the print medium P. The first central target temperature is equal to or less than the third set temperature.

In operation 945, when there is no image for the third area of the print medium P, the fixing device 80 may determine whether there is an image for the fourth area.

In operation 950, the fixing device 80 may set the end target temperature as a second end target temperature lower than the first end target temperature when there is an image for the fourth area of the print medium P.

In operation 955, the fixing device 80 may set the end target temperature as a third end target temperature lower than the second end target temperature when there is no image for the fourth area of the print medium P.

In operation 960, the fixing device 80 may control power supplied to the first heat source 83-1 such that the temperature sensed by the first temperature sensor 89-1 reaches the set end target temperature.

In operation 965, the fixing device 80 may determine whether there is a next page to be printed. When there is a next page to be printed, returning to operation 910, a process of controlling the end target temperature for the next page and a process of controlling the central target temperature may independently proceed, and when there is no next page to be printed, the print job may end. The fixing device 80, for each page to be printed, may independently perform the processes (corresponding to operations 935 to 960) of controlling the end target temperature and the processes (corresponding to operations 915 to 930) of controlling the central target temperature, respectively.

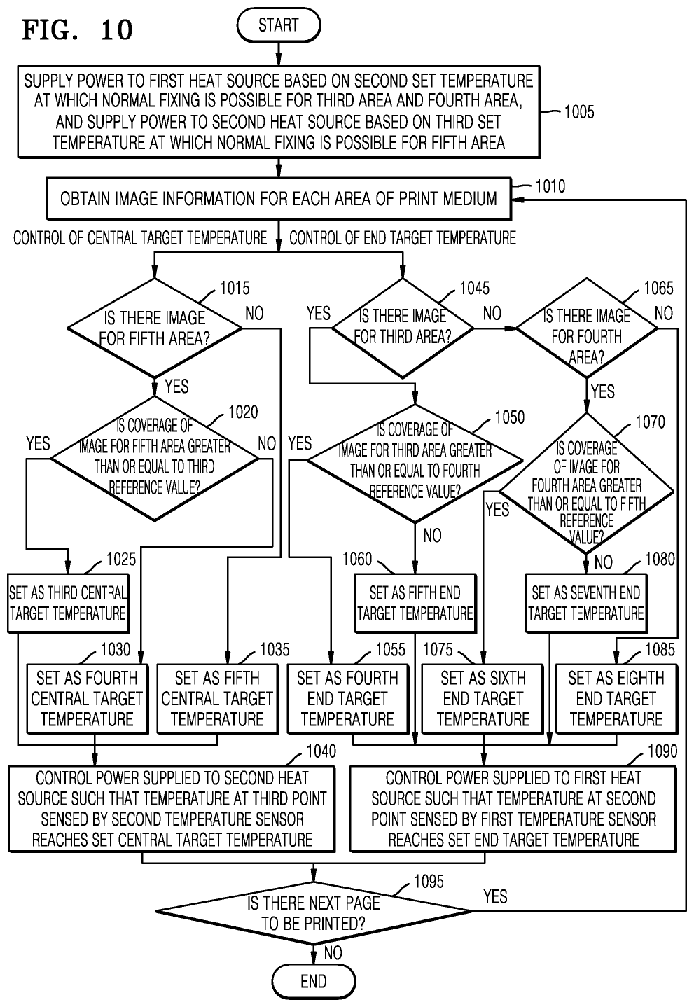

FIG. 10 illustrates a method of controlling a temperature of a fixing device including a plurality of heat sources according to an example.

Referring to FIG. 10, the fixing device 80 may supply power to the first heat source 83-1 based on a second set temperature at which normal fixing is possible for third and fourth areas, and may supply power to the second heat source 83-2 based on a third set temperature at which normal fixing is possible for a fifth area in operation 1005. The fixing device 80 may supply power to the heating member 81 based on the second set temperature and the third set temperature at which normal fixing is possible for the entire area of the print medium P in a width direction corresponding to a longitudinal direction of the heating member 81. The fixing device 80 may supply power corresponding to the second set temperature and the third set temperature to the first heat source 83-1 for heating both end portions of the heat member 81 in the longitudinal direction and the third heat source 83-3 for heating a central portion between both end portions, respectively. However, such a process is not necessarily performed, and may be applied as a preceding process if necessary.

In operation 1010, the fixing device 80 may obtain image information for each area of the print medium P. For example, the fixing device 80 may obtain image information for each of the third area, the fourth area, and the fifth area of the print medium P of FIG. 8A or FIG. 8B. Thereafter, the fixing device 80 may independently perform processes (corresponding to operations 1045 to 1090) of controlling the end target temperature and processes (corresponding to operations 1015 to 1040) of controlling the central target temperature, respectively.

In operation 1015, the fixing device 80 may determine whether there is an image for the fifth area.

In block 1020, when there is an image for the fifth area, the fixing device 80 may determine whether the coverage of the image for the fifth area is greater than or equal to a third reference value or the image for the fifth area includes an image other than text. The third reference value may be a preset value, and the value may be changed by a user or an administrator.

In operation 1025, when the coverage of the image for the fifth area of the print medium P is greater than or equal to the third reference value, or when the image for the fifth area is not made of text only, the fixing device 80 may set the central target temperature to a third central target temperature. The third central target temperature is equal to or less than the third set temperature.

In operation 1030, when the coverage of the image for the fifth area of the print medium P is less than the third reference value, or when the image for the fifth area does not include an image other than text, the fixing device 80 may set the central target temperature to a fourth central target temperature lower than the third central target temperature.

In operation 1035, the fixing device 80 may set the central target temperature as a fifth central target temperature lower than the fourth central target temperature when there is no image for the fifth area of the print medium P.

In operation 1040, the fixing device 80 may control power supplied to the second heat source 83-2 such that the temperature at the third point sensed by the second temperature sensor 89-2 reaches the set central target temperature.

The example processes of operations 1015 to 1040 above for controlling the central target temperature may be modified and performed according to another example. For example, different from the example shown in FIG. 10, for each page to be printed, when there is an image for a front end area and a rear end area within a certain range from each of a leading edge and a trailing edge of the print medium P in a conveying direction in the fifth area, the fixing device 80 may set the central target temperature to an eighth central target temperature equal to or less than the third set temperature when the coverage of the image for the front end area and the rear end area is greater than or equal to a sixth reference value or when the image for the front end area and the rear end area includes an image other than text, and may set the central target temperature to a ninth central target temperature lower than the eighth set temperature when the coverage of the image for the front end area and the rear end area is less than the sixth reference value or when the image for the front end area and the rear end area does not include an image other than text. When there is no image for the front end area and the rear end area in the fifth area, the fixing device 80 may set the central target temperature to a tenth central target temperature when the coverage of the image for a central area between the front end area and the rear end area in the fifth area is greater than or equal to a seventh reference value or when the image for the central area includes an image other than text, and may set the central target temperature to an eleventh central target temperature lower than the ninth central target temperature and the tenth central target temperature when the coverage of the image for the central area is less than the seventh reference value or when the image for the central area does not include an image other than text. The fixing device 80 may control power supplied to the second heat source 83-2 such that the temperature at the third point sensed by the second temperature sensor 89-2 reaches the set central target temperature.

In another example, the fixing device 80 may set the central target temperature to a certain temperature regardless of the image information of the print medium P to control the power supplied to the second heat source 83-2, and the process for controlling the end target temperature may set the end target temperature based on the image information of the print medium P to control the power supplied to the first heat source 83-1.

Referring again to FIG. 10, in operation 1045, the fixing device 80 may determine whether there is an image for the third area of the print medium P.

In operation 1050, when there is an image for the third area of the print medium P, the fixing device 80 may determine whether the coverage of the image for the third area is greater than or equal to a fourth reference value or the image for the third area includes an image other than text. The fourth reference value may be a preset value that may be changed by a user or an administrator.

In operation 1055, when the coverage of the image for the third area of the print medium P is greater than or equal to the fourth reference value, or when the image for the third area includes an image other than text, the fixing device 80 may set the end target temperature to a fourth end target temperature below the second set temperature.

In operation 1060, when the coverage of the image for the third area of the print medium P is less than the fourth reference value, or when the image for the third area does not include an image other than text, the fixing device 80 may set the end target temperature to a fifth end target temperature lower than the fourth end target temperature.

In operation 1065, when there is no image for the third area of the print medium P, the fixing device 80 may determine whether there is an image for the fourth area.

In operation 1070, when there is an image for the fourth area of the print medium P, the fixing device 80 may determine whether the coverage of the image for the fourth area is greater than or equal to a fifth reference value or the image for the fourth area includes an image other than text. The fifth reference value may be a preset value that may be changed by a user or an administrator.

In operation 1075, when the coverage of the image for the fourth area of the print medium P is greater than or equal to the fifth reference value, or when the image for the fourth area includes an image other than text, the fixing device 80 may set the end target temperature to a sixth end target temperature.

In operation 1080, when the coverage of the image for the fourth area of the print medium P is less than the fifth reference value, or when the image for the fourth area does not include an image other than text, the fixing device 80 may set the end target temperature to a seventh end target temperature lower than the sixth end target temperature.

In operation 1085, the fixing device 80 may set the end target temperature as an eighth end target temperature lower than the seventh end target temperature when there is no image for the third and fourth areas of the print medium P.

In operation 1090, the fixing device 80 may control power supplied to the first heat source 83-1 such that a temperature at a second point sensed by the first temperature sensor 89-1 reaches the set end target temperature.

In operation 1095, the fixing device 80 may determine whether there is a next page to be printed. When there is a next page to be printed, returning to operation 1010, the process of controlling the end target temperature for the next page and the process of controlling the central target temperature may independently proceed, and when there is no next page to be printed, the print job may end. The fixing device 80, for each page to be printed, may independently perform the processes (corresponding to operations 1045 to 1090) of controlling the end target temperature and the processes (corresponding to operations 1015 to 1040) of controlling the central target temperature, respectively.

The above-described example methods of controlling the temperature of the fixing device 80 may be implemented in the form of a non-transitory computer-readable recording medium storing instructions executable by a computer or a processor. The examples may be written as computer programs and may be implemented in general-use digital computers that execute programs using the non-transitory computer-readable recording medium. The non-transitory computer-readable recording medium may include read only memory (ROM), random access memory (RAM), flash memory, CD-ROMs, CD-Rs, CD+Rs, CD-DVD-Rs, DVD-Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, or solid-state disks (SSD), and may be any device capable of storing instructions or software, associated data, data files, and data structures, and providing the instructions or software, associated data, data files, and data structures to a processor or a computer such that the processor or computer may execute the instructions.

What is claimed is:

1. A fixing device comprising:
a heating member;
a pressing member to form a fixing nip with the heating member;
a temperature sensor to sense a temperature at a first point of the heating member; and
a processor to:
set a target temperature to be lower than a first set temperature at which normal fixing is possible for an entire area of a print medium in a case where a distribution of an image for a first area, which is a certain outer area of the print medium, is less than a certain criterion, and
control power supplied to the heating member such that the temperature at the first point sensed by the temperature sensor reaches the set target temperature.

2. The fixing device of claim 1, wherein the target temperature is lower as the distribution of the image for the first area is less.

3. The fixing device of claim 1, wherein the processor, according to a print job command, after supplying power to the heating member based on the first set temperature, is further to control the power supplied to the heating member by setting the target temperature.

4. The fixing device of claim 1, wherein the processor is further to:
set the target temperature as a first target temperature in a case where there is an image for the first area, and
set the target temperature to a second target temperature lower than the first target temperature in a case where there is no image for the first area.

5. The fixing device of claim 1, wherein, in a case where there is an image for the first area, the processor is further to:
set the target temperature to a third target temperature in a case where coverage of the image for the first area is greater than or equal to a first reference value or in a case where the image for the first area includes an image other than text, and
set the target temperature to a fourth target temperature lower than the third target temperature in a case where the coverage of the image for the first area is less than the first reference value or in a case where the image for the first area does not include an image other than text.

6. The fixing device of claim 1, wherein the processor, in a case where there is no image for the first area, is further to:
set the target temperature to a fifth target temperature in a case where coverage of an image for a second area excluding the first area in the entire area of the print medium is greater than or equal to a second reference value or in a case where the image for the second area includes an image other than text, and
set the target temperature to a sixth target temperature lower than the fifth target temperature in a case where the coverage of the image for the second area is less than the second reference value or in a case where the image for the second area does not include an image other than text.

7. The fixing device of claim 1, wherein the first area comprises an area within a first range from each of a leading edge and a trailing edge of the print medium in a conveying direction and an area within a second range from both edges of the print medium in a width direction.

8. The fixing device of claim 1, wherein, in a case where the heating member comprises a first heat source heating both end portions of the heating member and a second heat source heating a central portion between both end portions, in a case where the temperature sensor comprises a first temperature sensor sensing a temperature at a second point of either one of both end portions, and in a case where the print medium comprises a third area and a fourth area fixed by both end portions, the processor is further to:
set an end target temperature to be lower than a second set temperature at which normal fixing is possible for the third area and the fourth area in a case where a distribution of an image for the third area, which is an outer area than the fourth area, is less than a certain criterion, and
control power supplied to the first heat source such that the temperature at the second point sensed by the first temperature sensor reaches the set end target temperature.

9. The fixing device of claim 8, wherein the end target temperature is lower as the distribution of the image for the third area is less.

10. The fixing device of claim 8, wherein the processor, according to a print job command, after supplying power to the first heat source based on the second set temperature, is further to control the power supplied to the first heat source by setting the end target temperature.

11. The fixing device of claim 8,
wherein, in a case where there is an image for the third area, the processor is further to set the end target temperature as a first end target temperature, and
wherein, in a case where there is no image for the third area, the processor is further to:
set the end target temperature to a second end target temperature lower than the first end target temperature in a case where there is an image for the fourth area, and
set the end target temperature to a third end target temperature lower than the second end target temperature in a case where there is no image for the fourth area.

12. The fixing device of claim 8, wherein, in a case where the temperature sensor further comprises a second temperature sensor to sense a temperature at a third point of the central portion, and in a case where the print medium further comprises a fifth area fixed by the central portion, the processor is further to:
set a central target temperature lower than a third set temperature at which normal fixing is possible for the fifth area in a case where a distribution of an image for the fifth area is less than a certain criterion, and
control power supplied to the second heat source such that the temperature at the third point sensed by the second temperature sensor reaches the set central target temperature.

13. The fixing device of claim 8, wherein, in a case where there is an image for the third area, the processor is further to:
set the end target temperature to a fourth end target temperature in a case where coverage of the image for the third area is greater than or equal to a fourth reference value or in a case where the image for the third area includes an image other than text, and
set the end target temperature to a fifth end target temperature lower than the fourth end target temperature in a case where the coverage of the image for the third area is less than the fourth reference value or in a case where the image for the third area does not include an image other than text.

14. The fixing device of claim 8,
wherein, in a case where there is no image for the third area, the processor, in a case where there is an image for the fourth area, is further to:
set the end target temperature to a sixth end target temperature in a case where coverage of the image for the fourth area is greater than or equal to a fifth reference value or in a case where the image for the fourth area includes an image other than text, and
set the end target temperature to a seventh end target temperature lower than the sixth end target temperature in a case where the coverage of the image for the fourth area is less than the fifth reference value or in a case where the image for the fourth area does not include an image other than text, and
wherein, in a case where there is no image for the fourth area, the processor is further to set the end target temperature to an eighth end target temperature lower than the seventh end target temperature.

15. A method of controlling a temperature of a fixing device, the method comprising:
setting a target temperature lower than a first set temperature at which normal fixing is possible for an entire area of a print medium in a case where a distribution of an image for a first area, which is a certain outer area of the print medium, is less than a certain criterion; and
controlling power supplied to a heating member of the fixing device such that a temperature at a first point sensed by a temperature sensor to sense the temperature at the first point of the heating member of the fixing device.
